(19) United States
(12) Patent Application Publication
(10) Pub. No.: US 2013/0028510 A1
(43) Pub. Date: Jan. 31, 2013

(54) IMAGE PROCESSING APPARATUS

(71) Applicants: Jun Kiyama, Higashiosaka-shi (JP); Masayoshi Okamoto, Daito-shi (JP)

(72) Inventors: Jun Kiyama, Higashiosaka-shi (JP); Masayoshi Okamoto, Daito-shi (JP)

(73) Assignee: SANYO ELECTRIC CO., LTD., Osaka (JP)

(21) Appl. No.: 13/558,929

(22) Filed: Jul. 26, 2012

(30) Foreign Application Priority Data
Jul. 27, 2011 (JP) 2011-164563

(51) Int. Cl. G06K 9/00

(52) U.S. Cl. 382/162

(57) ABSTRACT

An image processing apparatus includes a searcher. A searcher searches for a partial image expressing a sentence on a color image. A first designator designates the color image as a recorded image when a search result of the searcher indicates “non-detected”. A second designator designates a single-color N graduation image (N: an integer of 3 or more) that is based on the color image, as the recorded image, when a ratio of the partial image detected by the searcher falls below a reference. A third designator designates a binary image that is based on the color image, as the recorded image, when the ratio of the partial image detected by the searcher is equal to more than a reference.

### CROSS REFERENCE OF RELATED APPLICATION

The disclosure of Japanese Patent Application No. 2011-164563, which was filed on Jul. 27, 2011, is incorporated herein by reference.

### BACKGROUND OF THE INVENTION

1. Field of the Invention

The present invention relates to an image processing apparatus, and in particular, relates to an image processing apparatus which performs a process for recording a color image.

2. Description of the Related Art

According to one example of this type of apparatus, image data, which is read by a scanner, representing a text, a drawing, a table, a photograph, etc., is subjected to a binarizing process, and then, accommodated in an image memory. Ablack image count portion creates a histogram indicating a distribution state of black pixels in a vertical direction and a horizontal direction, and writes the created histogram in a histogram memory. A text region, a drawing region, a table region, and a photograph region are classified based on the histogram thus obtained.

However, in the above-described apparatus, the region classification referring to the histogram is not reflected on a recording of the image data, and thus, there is a limit to a recording performance.

### SUMMARY OF THE INVENTION

An image processing apparatus according to the present invention comprises: a searcher which searches for a partial image expressing a sentence on a color image; a first designator which designates the color image as a recorded image when a search result of the searcher indicates non-detected; a second designator which designates a single-color N graduation image (N: an integer of 3 or more) that is based on the color image, as the recorded image, when a ratio of the partial image detected by the searcher falls below a reference; and a third designator which designates a binary image that is based on the color image, as the recorded image, when the ratio of the partial image detected by the searcher is equal to or more than a reference.

According to the present invention, an image processing program which is recorded on a non-transitory recording medium in order to control an image processing apparatus, the program causes a processor of the image processing apparatus to execute the steps comprising: a searching step of searching for a partial image expressing a sentence on a color image; a first designating step of designating the color image as a recorded image when a search result of the searching step indicates non-detected; a second designating step of designating a single-color N graduation image (N: an integer of 3 or more) that is based on the color image, as the recorded image, when a ratio of the partial image detected in the searching step falls below a reference; and a third designating step of designating a binary image that is based on the color image, as the recorded image, when the ratio of the partial image detected in the searching step is equal to or more than a reference.

According to the present invention, an image processing method executed by an image processing apparatus, comprises: a searching step of searching for a partial image expressing a sentence on a color image; a first designating step of designating the color image as a recorded image when a search result of the searching step indicates non-detected; a second designating step of designating a single-color N graduation image (N: an integer of 3 or more) that is based on the color image, as the recorded image, when a ratio of the partial image detected in the searching step falls below a reference; and a third designating step of designating a binary image that is based on the color image, as the recorded image, when the ratio of the partial image detected in the searching step is equal to or more than a reference.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3(A) is an illustrative view showing one example of a document on which only a text is printed;

FIG. 3(B) is an illustrative view showing one example of a document on which a text and a photograph are printed;

FIG. 3(C) is an illustrative view showing one example of a document on which only a photograph is printed;

FIG. 4 is an illustrative view showing one example of a distribution state of determination blocks assigned to a binary image;

FIG. 5(A) is an illustrative view showing one example of a configuration of a register referred to by a CPU of the embodiment in FIG. 2;

FIG. 5(B) is an illustrative view showing one example of a configuration of another register referred to by the CPU of the embodiment in FIG. 2;

FIG. 6 is an illustrative view showing one example of a process for searching a region in which an image expressing a sentence appears;

FIG. 7 is an illustrative view showing one example of a process for designating a binary image as a recorded image;

FIG. 8 is an illustrative view showing one example of a process for designating a gray scale image as a recorded image;

FIG. 9 is an illustrative view showing one example of a process for designating a color image as a recorded image;

FIG. 10 is a flowchart showing one portion of behavior of a CPU applied to the embodiment in FIG. 2;

FIG. 11 is a flowchart showing another portion of the operation of the CPU applied to the embodiment in FIG. 2;

FIG. 12 is a flowchart showing still another portion of the operation of the CPU applied to the embodiment in FIG. 2;

FIG. 13 is a flowchart showing yet another portion of the operation of the CPU applied to the embodiment in FIG. 2;

FIG. 14 is a block diagram showing a configuration of another embodiment of the present invention;

FIG. 15 is an illustrative view showing another example of a distribution state of the determination blocks assigned to the binary image; and

FIG. 16 is a flowchart showing one portion of an operation of a CPU applied to still another embodiment of the present invention.

### DETAILED DESCRIPTION OF THE PREFERRED EMBODIMENTS

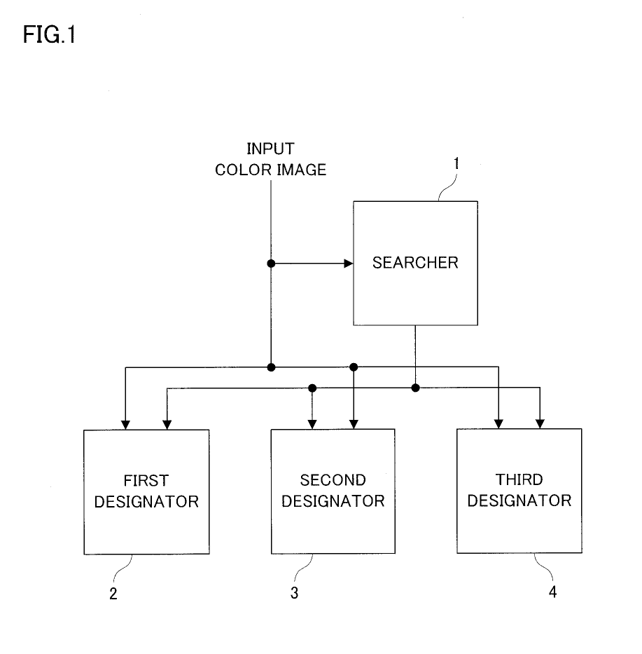

With reference to FIG. 1, an image processing apparatus of one embodiment of the present invention is basically configured as follows: A searcher 1 searches for a partial image expressing a sentence on a color image. A first designator 2 designates the color image as a recorded image when a search result of the searcher 1 indicates “non-detected”. A second designator 3 designates a single-color N graduation image (N: an integer of 3 or more) that is based on the color image, as the recorded image, when a ratio of the partial image detected by the searcher 1 falls below a reference. A third designator 4 designates a binary image that is based on the color image, as the recorded image, when the ratio of the partial image detected by the searcher 1 is equal to more than a reference.

Unless a partial image expressing a sentence is detected from a color image, a color image is designated as a recorded image. When the partial image expressing the sentence is detected from the color image but a ratio of the partial image falls below a reference, a single-color N gradation image that is based on the color image is designated as the recorded image. When the partial image expressing the sentence is detected from the color image and the ratio of the partial image exceeds a reference, a binary image that is based on the color image is designated as the recorded image. This serves the appropriate sizing of the recorded image, and as a result, a recording performance is improved.

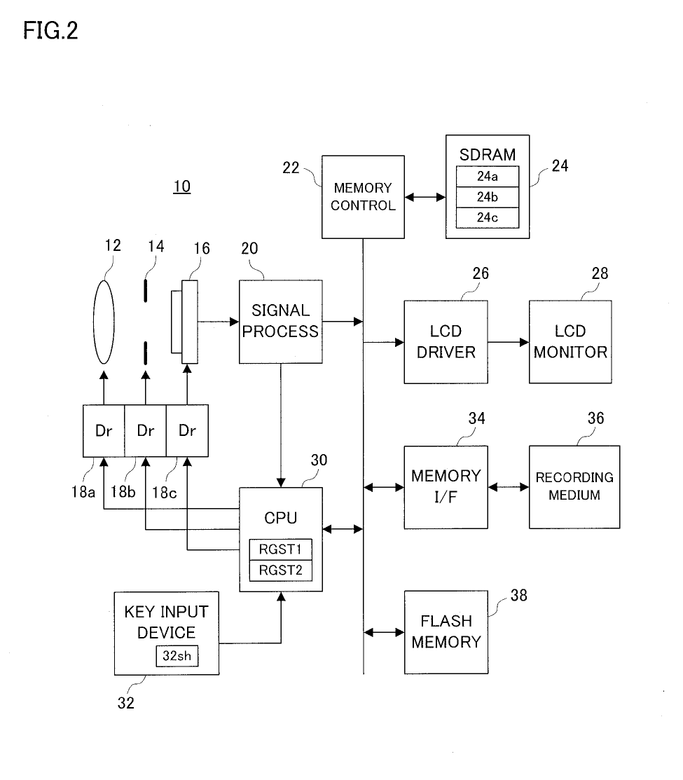

With reference to FIG. 2, a digital camera 10 according to this embodiment includes a focus lens 12 and an aperture unit 14 respectively driven by drivers 18a and 18b. An optical image that has undergone these components enters, with irradiation, an imaging surface of an imager 16. On the imaging surface, a plurality of light-receiving elements are arrayed two-dimensionally. Furthermore, the imaging surface is covered with a primary color filter in which color elements of R (red), G (green), or B (blue) are arrayed in mosaic. Herein, the color element and the light-receiving element correspond one-to-one, and an amount of electric charges generated by each of the light-receiving elements reflects the intensity of light that has undergone the color element covering the light-receiving element.

When a power source is applied, a CPU 30 commands a driver 18c to repeat exposure behavior and electric-charge reading-out behavior in order to start a moving-image taking process. In response to a vertical synchronization signal Vsync that is cyclically generated, the driver 18c exposes the imaging surface of the imager 16 and reads out electric charges produced on the imaging surface in a raster scanning manner. From the imager 16, raw image data based on the read-out electric charges is cyclically outputted.

A signal processing circuit 20 performs processes, such as white balance adjustment, color separation, and YUV conversion, on the raw image data outputted from the imager 16. YUV-formatted color image data generated thereby is written into a YUV image area 24a of an SDRAM 24 through the memory control circuit 22. An LCD driver 26 repeatedly reads out the color image data accommodated in the YUV image area 24a through the memory control circuit 22, and drives an LCD monitor 28 based on the read-out color image data. As a result, a real-time moving image (live view image) representing a scene that is taken on the imaging surface is displayed on a monitor screen.

Moreover, the signal processing circuit 20 applies Y data forming the color image data to the CPU 30. The CPU 30 performs an AE process on the applied Y data so as to calculate an appropriate EV value, and sets an aperture amount and an exposure time which define the calculated appropriate EV value, to the drivers 18b and 18c, respectively. Thereby, a brightness of the live view image is moderately adjusted.

When a shutter button 32sh provided in a key input device 32 is half-depressed, the CPU 30 performs a strict AE process on the Y data applied from the signal processing circuit 20 so as to calculate an optimal EV value. Similarly to the above-described case, an aperture amount and an exposure time that define the calculated optimal EV value are set to the drivers 18b and 18c, respectively. As a result, the brightness of the live view image is adjusted strictly. Moreover, the CPU 30 performs an AF process on a high-frequency component of the Y data applied from the signal processing circuit 20. Thereby, the focus lens 12 is placed at a focal point, and the sharpness of the live view image is improved.

When the shutter button 32sh is fully depressed, the CPU 30 executes a still image taking process. As a result, the color image data representing a scene at the time point at which the shutter button 32sh is fully depressed is retreated from the YUV image area 24a to a still image area 24b.

A photograph mode is switched between a normal mode and a document photograph mode. When the photograph mode at this time point is the normal mode, the CPU 30 designates the color image data that is retreated to the still image area 24b, as recorded image data, and commands a memory I/F 34 to execute a recording process.

In response thereto, when the photograph mode at this time point is the document photograph mode, the CPU 30 executes a pre-recording process. As a result, the color image data that is retreated to the still image area 24b is designated as the recorded image data, or the gray scale image data or the binary image data created, in the work area 24c, based on the retreated color image data is designated as the recorded image data. Upon completion of the pre-recording process, the CPU 30 commands the memory I/F 34 to execute the recording process.

The memory I/F 34 reads out the recorded image data designated on the still image area 24b or on the work area 24c through the memory control circuit 22 from the work area 24c, and records an image file in which the read-out recorded image data is contained, in a recording medium 52.

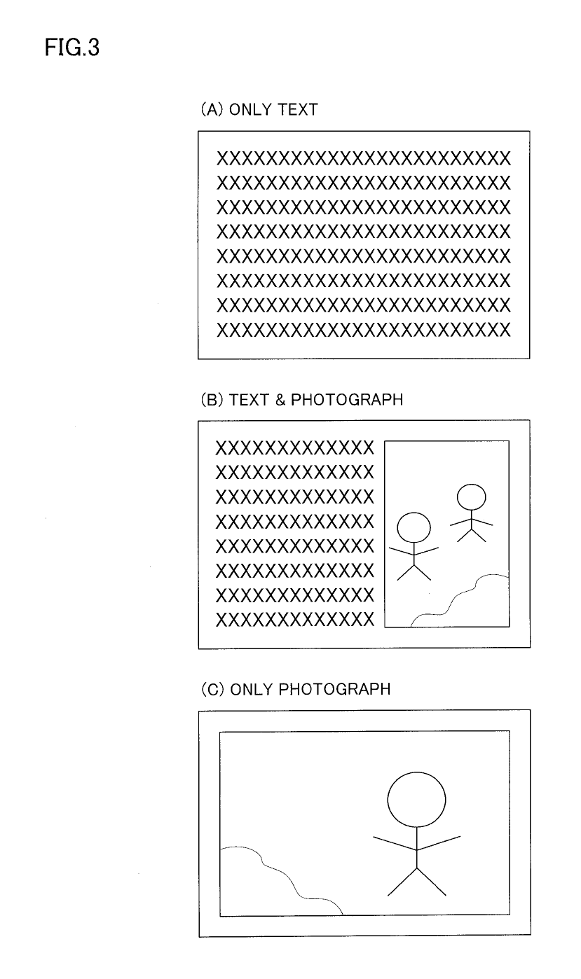

The pre-recording process is executed according to a procedure described below, on the precondition that a document on which only a text is printed, as shown in FIG. 3(A), a document on which a photograph (or a drawing), in addition to the text, is printed, as shown in FIG. 3(B), or a document on which only a photograph (or a drawing) is printed, as shown in FIG. 3(C), is photographed.

Firstly, the color image data that is retreated to the still image area 24b is converted to binary image data as a result of the binarizing process. The converted binary image data is expressed by a numeral value (=1) representing a black pixel and a numeral value (=0) representing a white pixel, and accommodated in the work area 24c.

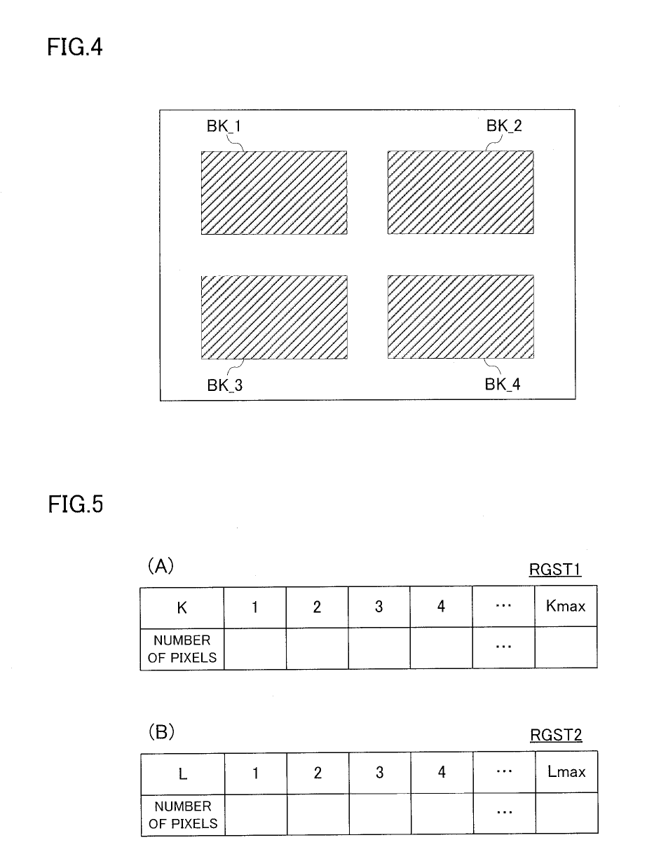

Thereafter, four determination blocks BK_1 to BK_4 are assigned to the binary image data accommodated in the work area 24c. Each of the determination blocks BK_1 to BK_4 has a vertical Kmax pixel x a horizontal Lmax pixel, and is assigned onto the binary image data as shown in FIG. 4. It is noted that “Kmax” and “Lmax” are each equivalent to an integer of 2 or more.

The assigned determination blocks BK_1 to BK_4 are designated in order, and the black pixel present in the designated determination block is counted as described below.

Firstly, a variable K is set to each of “1” to “Kmax”, and the number of black pixels distributed to a K-th horizontal pixel column, out of Kmax horizontal pixel columns belonging to the designated determination block, is counted. A count value is written to a register RGST1 shown in FIG. 5(A) corresponding to a value of the variable K. Next, a variable L is set to each of “1” to “Lmax”, and the number of black pixels distributed to an L-th vertical pixel column, out of Lmax vertical pixel columns belonging to the designated determination block, is counted. A count value is written to a register RGST2 shown in FIG. 5(B) corresponding to a value of the variable L.

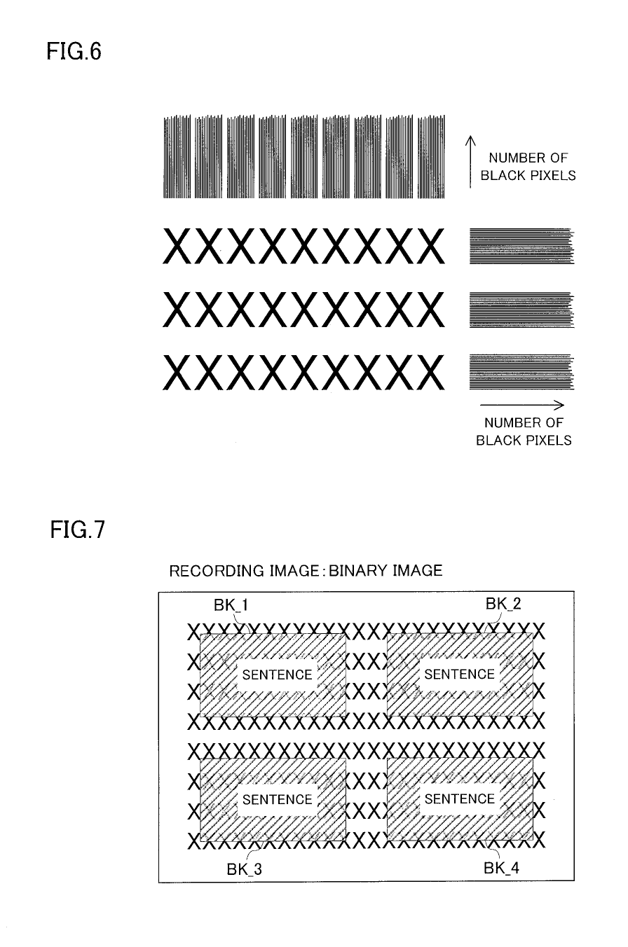

When a horizontally-written sentence shown in FIG. 3(A) or FIG. 3(B) is noticed, the number of black pixels changes in a vertical direction and a horizontal direction, as shown in FIG. 6. Numerical values of the registers RGST1 and RGST2 indicate such number of black pixels.

Upon completion of counting the number of black pixels, a pattern defined by a setting value of the register RGST1 and/or the register RGST2 is checked with a sentence pattern. The sentence pattern is equivalent to a pattern in which a group of count values exceeding a threshold value and a group of count values indicating “0” alternatingly appear for a plurality of number of times. When the horizontally written sentence appears in the determination block, the pattern defined by the setting value of the register RGST1 matches the sentence pattern. On the other hand, when the vertically written sentence appears in the determination block, the pattern defined by the setting value of the register RGST2 matches the sentence pattern.

When a determination block in which the pattern matching the sentence pattern appears is detected, a variable STC of which the initial value indicates “0” is incremented. Upon completion of the above-described checking process on all of the determination blocks BK_1 to BK_4, the variable STC will indicate a sentence ratio (or size) appearing in the binary image data.

When the variable STC is “0”, it is regarded that the sentence does not appear in the binary image data. At this time, the color image data that is retreated to the still image area 24b is designated as the recorded image data. When the variable STC is “4”, it is regarded that the sentence having a ratio more than a reference appears in the binary image data. At this time, the binary image data that is accommodated in the work area 24c is designated as the recorded image data.

When the variable STC is any one of “1” to “3”, it is regarded that the sentence appears in the binary image data but the sentence ratio falls below the reference. At this time, the gray scale image data that is based on the color image data that is retreated to the still image area 24b is created on the work area 24c, and the created gray scale image data is designated as the recorded image data.

When a document shown in FIG. 3(A) is photographed, all of the patterns of the blocks BK_1 to BK_4 match the sentence pattern, and the variable STC indicates “4”. As a result, the binary image data is designated as the recorded image data (refer to FIG. 7).

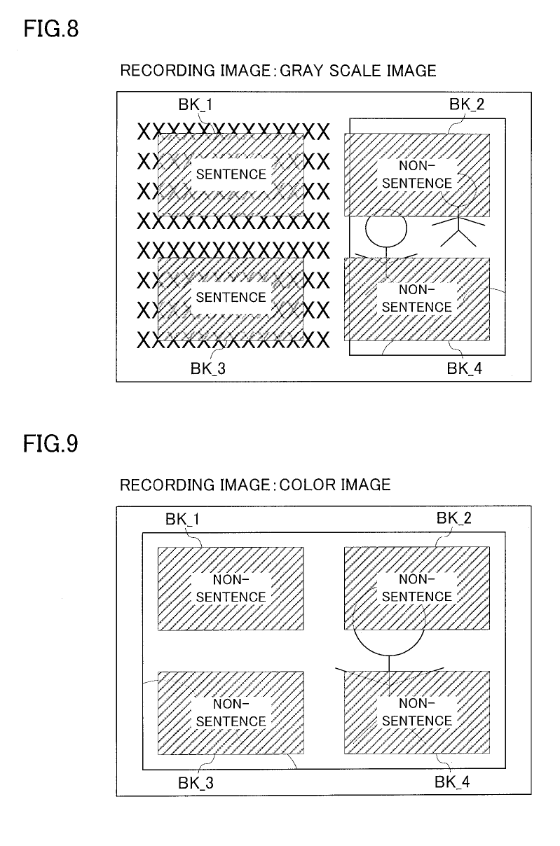

When a document shown in FIG. 3(B) is photographed, only the patterns of the blocks BK_1 and BK_3 match the sentence pattern, and the variable STC indicates “2”. As a result, the gray scale image data is designated as the recorded image data (refer to FIG. 8).

When a document shown in FIG. 3(C) is photographed, neither of the patterns of the blocks BK_1 to BK_4 match the sentence pattern, and the variable STC indicates “0”. As a result, the color image data is designated as the recorded image data (refer to FIG. 9).

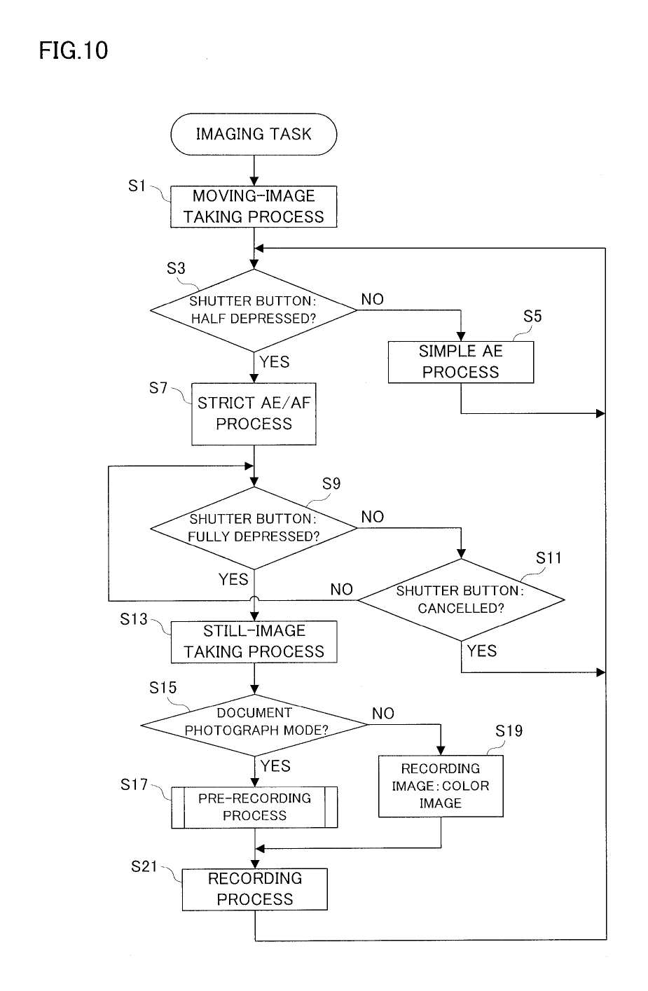

The CPU 30 executes a plurality of tasks, including an imaging task shown in FIG. 10 to FIG. 13, in a parallel manner, under the control of a multitask OS. It is noted that control programs corresponding to these tasks are stored in a flash memory 38.

With reference to FIG. 10, in a step S1, the moving-image taking process is executed. As a result, the live view image is displayed on the LCD monitor 28. In a step S3, it is determined whether or not the shutter button 32sh is half-depressed, and as long as a determined result is NO, a simple AE process in a step S5 is repeated. As a result, the brightness of the live view image is adjusted moderately. When the shutter button 32sh is half-depressed, the strict AE process and AF process are executed in a step S7. As a result, the brightness and the sharpness of the live view image are adjusted strictly.

In a step S9, it is determined whether or not the shutter button 32sh is fully depressed. In a step S11, it is determined whether or not the manipulation of the shutter button 32sh is canceled. When the determined result in the step Sll is YES, the process returns to the step S3, and when the determined result in the step S9 is YES, the still image taking process is executed in a step S13. As a result of the process in the step S13, the color image data representing the scene at the time point at which the shutter button 32sh is fully depressed is retreated from the YUV image area 24a to the still image area 24b.

Upon completion of the still image taking process, it is determined whether or not the operation mode at the current time point is the document photograph mode in a step S15. When the determined result is NO, the process proceeds to a step S19, and the color image data that is retreated to the still image area 24b is designated as the recorded image data. On the other hand, when a determined result is YES, the pre-recording process is executed in a step S17. As a result, the color image data that is retreated to the still image area 24b is designated as the recorded image data, or the gray scale image data or the binary image data created on the work area 24c based on the retreated color image data is designated as the recorded image data.

Upon completion of the process of the step S17 or S19, the process proceeds to a step S21, and the memory I/F 34 is commanded to execute the recording process. The memory I/F 34 reads out the recorded image data designated in the still image area 24b or the work area 24c through the memory control circuit 22, and records an image file in which the read-out recorded image data is contained, into the recording medium 36. Upon completion of the recording process, the process returns to the step S3.

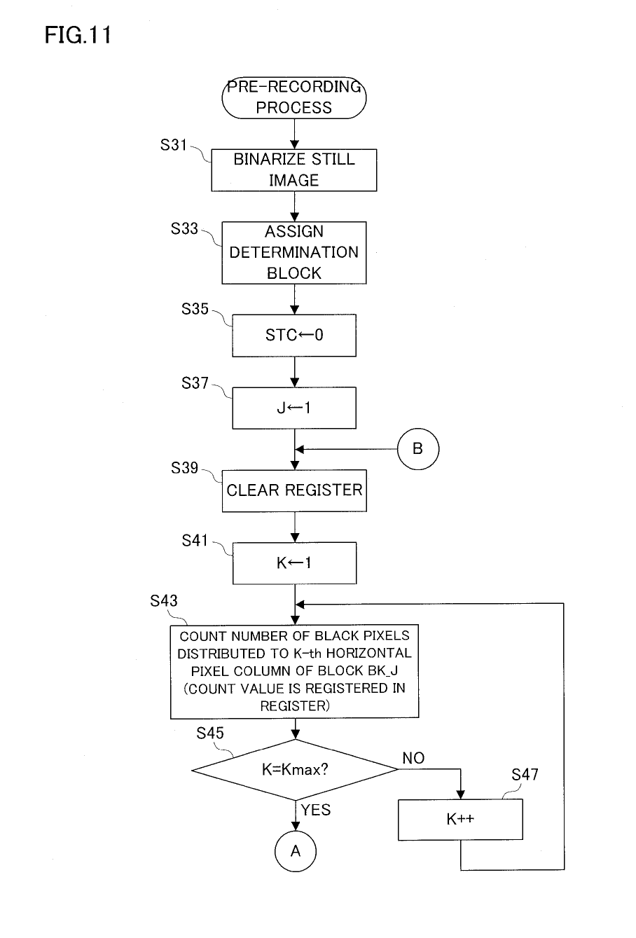

The pre-recording process in the step S17 is executed according to a subroutine shown in FIG. 11 to FIG. 13. In a step S31, the binarizing process is performed on the color image data that is retreated to the still image area 24b so as to create the binary image data. The converted binary image data is expressed by a numeral value (=1) representing a black pixel and a numeral value (=0) representing a white pixel, and accommodated in the work area 24c.

In a step S33, the four determination blocks BK_1 to BK_4, each of which has a horizontal Kmax pixel x a vertical Lmax pixel, are assigned to the binary image data accommodated in the work area 24c. In a step S35, the variable STC is set to “0”, in a step S37, the variable J is set to “1”, and in a step S39, the registers RGST1 and RGST2 are cleared. In a step S41, the variable K is set to “1”, and in a step S43, the number of black pixels distributed to the K-th horizontal pixel column, out of the Kmax horizontal pixel columns belonging to the determination block BK_J, is counted. The count value is written to the register RGST1 corresponding to the value of the variable K. In a step S45, it is determined whether or not the variable K reaches “Kmax”, and when a determined result is NO, the process returns to the step S43 after incrementing the variable K in a step S47 while when the determined result is YES, the process proceeds to a step S49.

In the step S49, the variable L is set to “1”, and in a step S51, the number of black pixels distributed to the L-th vertical pixel column, out of the Lmax vertical pixel columns belonging to the determination block BK_J, is counted. The count value is written to the register RGST2 corresponding to the value of the variable L. In a step S53, it is determined whether or not the variable L reaches “Lmax”, and when a determined result is NO, the process returns to the step S51 after incrementing the variable L in a step S55 while when the determined result is YES, the process proceeds to a step S57.

In the step S57, the pattern indicated by the setting value of the register RGST1 and/or the register RGST2 is checked with the predefined sentence pattern. In a step S59, it is determined based on the checking result of the step S57 whether or not the partial image belonging to the determination block BK_J is equivalent to the image representing the sentence. When a determined result is NO, the process proceeds directly to a step S63, and when the determined result is YES, the process proceeds to the step S63 after incrementing the variable STC in a step S61.

In the step S63, it is determined whether or not the variable J reaches “4”, and when a determined result is NO, the process returns to the step S39 after incrementing the variable J in a step S65 while when the determined result is YES, the process proceeds to a step S67. In the step S67, it is determined whether or not the variable STC is “0”, and in a step S71, it is determined whether or not the variable STC is “4”.

When a determined result in the step S67 is YES, the process proceeds to a step S69, regarding that the sentence is not appeared in the binary image data, so as to designate the color image data that is retreated to the still image area 24b as the recorded image data. When a determined result in the step S71 is YES, the process proceeds to a step S73, regarding that the sentence having a ratio or a size more than the reference is appeared in the binary image data, so as to designate the binary image data accommodated in the work area 24c as the recorded image data. Upon completion of the process in the step S69 or S73, the process is returned to a routine at an upper hierarchical level.

If the determined result in the step S67 and the determined result in the step S71 are both NO, the process proceeds to a step S75 regarding that the sentence appears in the binary image data but the ratio or the size of the sentence falls below the reference. In the step S75, the color image data that is retreated to the still image area 24b is converted to the gray scale image data. The converted gray scale image data is accommodated in the work area 24c. In a step S77, the converted gray scale image data is designated as the recorded image data, and upon completion of the designation, the process returns to the routine at a hierarchical upper level.

As can be seen from the above-described description, the CPU 30 searches for the partial image representing the sentence from the color image data that is retreated to the still image area 24b, in response to the full depression of the shutter button 32sh (S31 to S65). When the search result indicates “non-detected”, the CPU 30 designates the retreated color image data as the recorded image data (S69). When the search result indicates “detected” but the ratio of the detected partial image falls below the reference, the CPU 30 designates, as the recorded image data, the gray scale image data that is based on the retreated color image data (S75 to S77). When the search result indicates “detected” and the ratio of the detected partial image is equal to or more than the reference, the CPU 30 designates, as the recorded image data, the binary image data that is based on the retreated color image data (S73). This serves the appropriate sizing of the recorded image data, and as a result, a recording performance is improved.

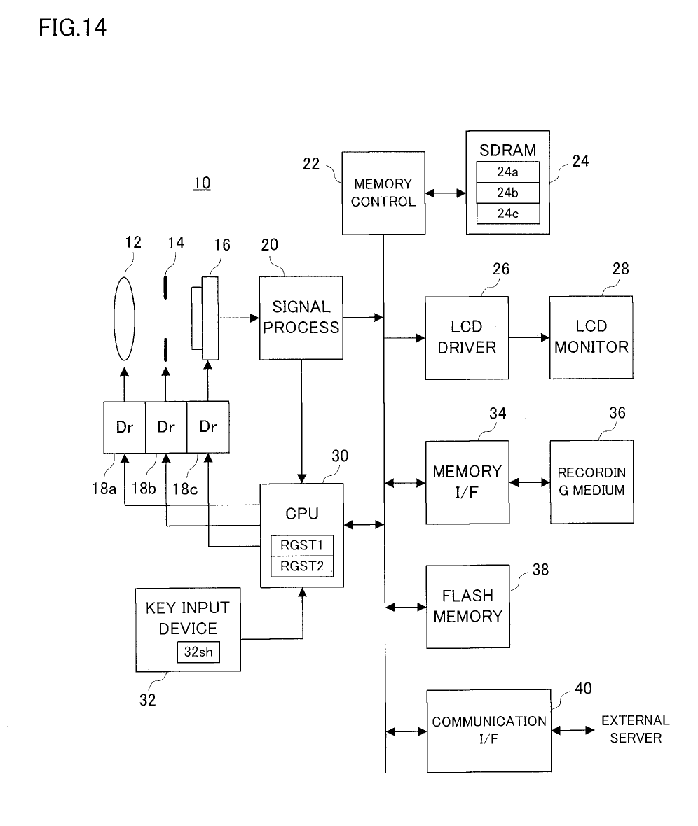

Furthermore, in this embodiment, the multi-task OS and the control program equivalent to the plurality of tasks executed by this are stored in advance in the flash memory 38. However, as shown in FIG. 14, by providing a communication IT 40 on the digital camera 10, while preparing one part of the control program on the flash memory 38 from the beginning as an internal control program, other parts of the control program may be obtained from an external server as an external control program. In this case, the above-described operations are implemented by the cooperation of the internal control program and the external control program.

Also, in this embodiment, the processes executed by the CPU 30 are divided into a plurality of tasks in the manner described above. However, each of the tasks may be further divided into a plurality of smaller tasks, and furthermore, one portion of the plurality of the divided smaller tasks may be integrated with other tasks. Also, in a case of dividing each of the tasks into a plurality of smaller tasks, all or one portion of these may be obtained from an external server.

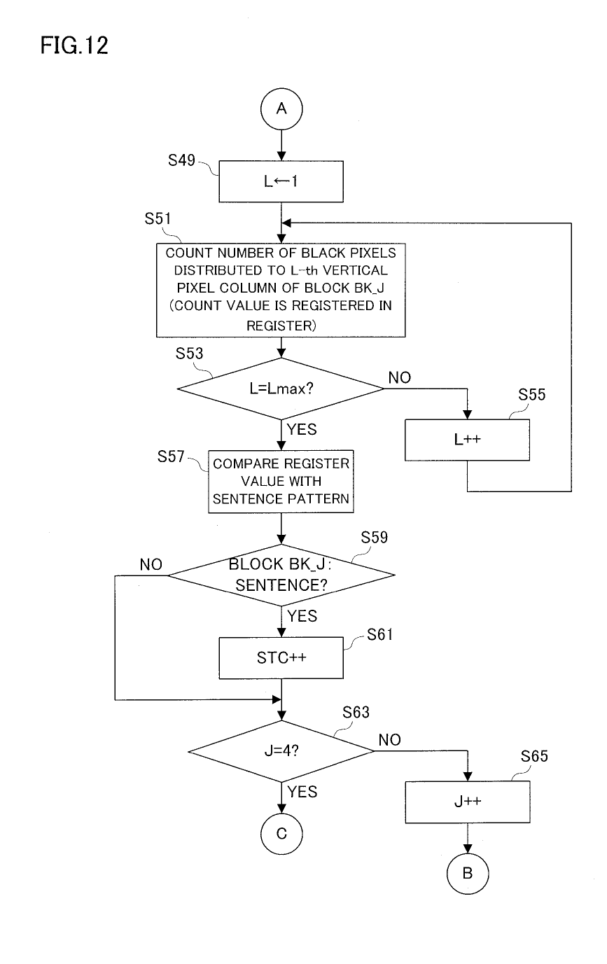

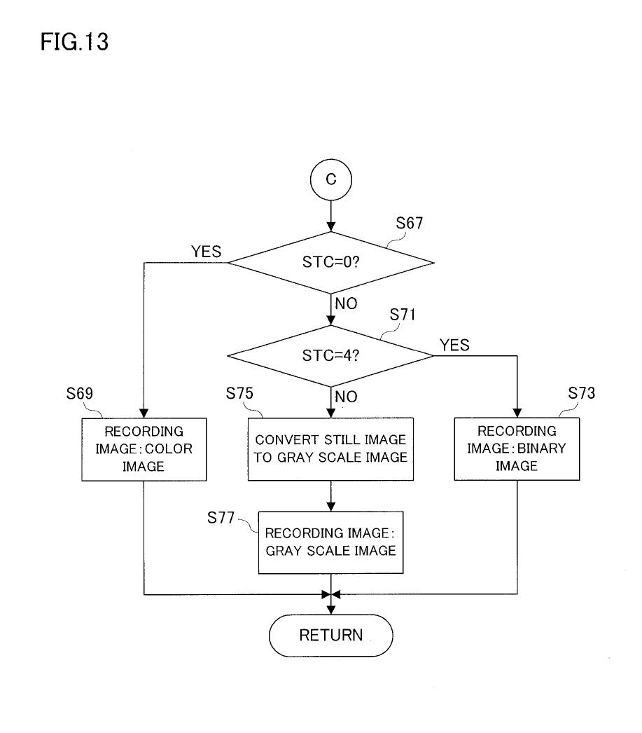

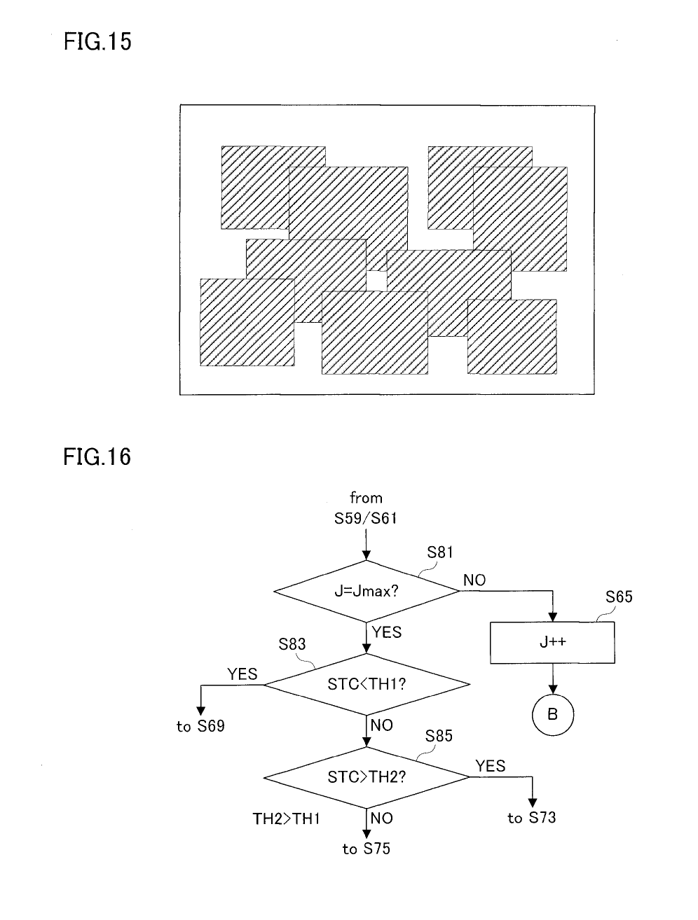

Furthermore, in this embodiment, the determination blocks BK_1 to BK_4 have the same size as each other and are assigned to the binary image data in a respectively non-overlapping manner (see FIG. 4). However, as shown in FIG. 15, a plurality of determination blocks having a respectively different size may be assigned to the binary image data in a manner that neighboring determination blocks partially overlap. In this case, a process for assigning the plurality of determination blocks to the binary image data in a manner shown in FIG. 15 needs to be executed in the step S33 shown in FIG. 11, and a process shown in FIG. 12 and FIG. 13 needs to be partially modified as shown in FIG. 16.

With reference to FIG. 16, in a step S81 that is executed subsequent to the step S59 or S61, it is determined whether or not the variable J reaches a maximum value Jmax (Jmax: total number of determination blocks). When a determined result is NO, the process proceeds to the step S65. When the determined result is YES, it is determined whether or not the variable STC falls below a threshold value TH1 in a step S83, and it is determined whether or not the variable STC exceeds a threshold value TH2 in a step S85. Herein, the threshold value TH2 is larger than the threshold value TH1. When a determined result in the step S83 is YES, the process proceeds to the step S69, when a determined result in the step S85 is YES, the process proceeds to the step S73, and when both of the determined results in the step S83 and the step S85 are NO, the process proceeds to the step S75.

Moreover, in this embodiment, the gray scale image is assumed as a single-color image having N gradations (N: an integer of 3 or more); however, an N-gradation image having a chromatic color such as red and blue rather than achromatic color such as gray may be adopted instead of the gray scale image.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
a searcher which searches for a partial image expressing a sentence on a color image;
a first designator which designates the color image as a recorded image when a search result of said searcher indicates non-detected;
a second designator which designates a single-color N graduation image (N: an integer of 3 or more) that is based on the color image, as the recorded image, when a ratio of the partial image detected by said searcher falls below a reference; and
a third designator which designates a binary image that is based on the color image, as the recorded image, when the ratio of the partial image detected by said searcher is equal to or more than the reference.

2. An image processing apparatus according to claim 1, wherein said searcher includes: a converter which converts the color image to a binary image; a designator which designates each of the plurality of blocks assigned to the binary image converted by said converter; and a determiner which determines whether or not the block designated by said designator is equivalent to the partial image, for each designation by said designator.

3. An image processing apparatus according to claim 2, wherein the plurality of blocks are assigned to the binary image in a partially overlapping manner.

4. An image processing apparatus according to claim 2, wherein said determiner includes: a first measurer which measures the number of pixels indicating a specific value, for each horizontal pixel column forming the block; a second measurer which measures the number of pixels indicating the specific value, for each vertical pixel column forming the block; and a checker which checks a pattern defined by a measurement result of said first measurer and/or said second measurer, to a predefined pattern.

5. An image processing apparatus according to claim 1, further comprising:
an imager which captures a scene through a lens; and
a creator which creates the color image based on output of said imager.

6. An image processing program which is recorded on a non-transitory recording medium in order to control an image processing apparatus, the program causes a processor of the image processing apparatus to execute the steps comprising:
a searching step of searching for a partial image expressing a sentence on a color image;
a first designating step of designating the color image as a recorded image when a search result of said searching step indicates non-detected;
a second designating step of designating a single-color N graduation image (N: an integer of 3 or more) that is based on the color image, as the recorded image, when a ratio of the partial image detected in said searching step falls below a reference; and
a third designating step of designating a binary image that is based on the color image, as the recorded image, when the ratio of the partial image detected in said searching step is equal to or more than a reference.

7. An image processing method executed by an image processing apparatus, comprising:
a searching step of searching for a partial image expressing a sentence on a color image;
a first designating step of designating the color image as a recorded image when a search result of said searching step indicates non-detected;
a second designating step of designating a single-color N graduation image (N: an integer of 3 or more) that is based on the color image, as the recorded image, when a ratio of the partial image detected in said searching step falls below a reference; and
a third designating step of designating a binary image that is based on the color image, as the recorded image, when the ratio of the partial image detected in said searching step is equal to or more than a reference.
